(19) United States
(12) Patent Application Publication
(10) Pub. No.: US 2019/0387857 A1
(43) Pub. Date: Dec. 26, 2019

(54) HEATING PLATE FOR ELECTRIC HAIR IRON HAVING SOFT SYNTHETIC RESIN INSERTED THEREIN AND METHOD FOR MANUFACTURING SAME

(71) Applicant: RBS CO.,LTD., Incheon (KR)

(72) Inventor: Wan Soo LIM, Incheon (KR)

(21) Appl. No.: 16/491,316

(22) PCT Filed: Aug. 18, 2017
(86) PCT No.: PCT/KR2017/009021

§ 371 Date: Sep. 5, 2019

(30) Foreign Application Priority Data
Jun. 30, 2017 (KR) 10-2017-0083793

(51) Int. Cl. A45D 1/04; B29C 45/14; C08F 14/26; C08F 10/02; C08F 16/24

(52) U.S. Cl. CPC A45D 1/04; B29C 45/14311; C08F 14/26; B29K 2705/02; C08F 16/24; H05B 2203/017; B29C 2045/14327; C08F 10/02

(57) ABSTRACT

The present invention relates to a heating plate for an electric hair iron and a method for manufacturing the same. More specifically, the present invention relates to a heating plate for an electric hair iron having a soft synthetic resin inserted therein, wherein an aluminum heating plate having a plurality of grooves formed in a longitudinal direction on the front surface is ejected and the soft synthetic resin is inserted into the front surface and both sides of the aluminum heating plate which is in a state of being inserted into a mold such that part of the soft synthetic resin is insertedly integrated into the grooves. The soft synthetic resin is injected from the rear of the aluminum heating plate to the front surface thereof when injecting the soft synthetic resin such that a uniformly even soft synthetic resin layer is formed without generation of bubbles on the front surface by injecting. Accordingly, a hollow through-hole is formed between the grooves of the aluminum heating plate such that heat is uniformly transferred, and a ceramic coating layer is formed inside the groove such that heat is evenly transferred across the soft synthetic resin layer.

### TECHNICAL FIELD

The present invention relates to a heating plate for an electric hair iron and a method for manufacturing the same, and more specifically to a heating plate for an electric hair iron having a soft synthetic resin inserted therein and a method for manufacturing the same, in which an aluminum heating plate having a plurality of grooves formed in a longitudinal direction on the front surface thereof is prepared through injection molding, the soft synthetic resin is injected into the front surface and both side surfaces of the aluminum heating plate in a state of being inserted into a mold such that some of the soft synthetic resin is inserted into the grooves so as to be integrated with the aluminum heating plate, the soft synthetic resin is injected into the aluminum heating plate in a direction from the rear surface to the front surface of the aluminum heating plate when injecting the soft synthetic resin so that a uniform soft synthetic resin layer is formed without generating bubbles on the front surface of the aluminum heating plate, a hollow-type through hole is formed between the grooves of the aluminum heating plate so as to enable uniform heat transfer, and a ceramic coating layer is formed inside the grooves so as to enable uniform heat transfer to the soft synthetic resin layer.

### BACKGROUND ART

An electric hair iron is used to style and fix hair, and performs a function of straightening hair in a dry or curly state using heat, or the like.

Various kinds of electric hair irons have been developed and used to date, and an electric hair iron generally includes a tongs-type iron body including an upper body and a lower body.

A heating plate, which generates heat by receiving power, is interposed in a wire-sided connection surface between the upper and lower bodies, and hair is brought into contact with the heating plate and is then pulled, thus being capable of being managed.

As materials used for heating plates, it may be confirmed that a heating plate formed of aluminum having excellent thermal conductivity is installed on a heater (Korean Utility Model Registration No. 20-0242035, or Korean Patent Unexamined Publication No. 10-2012-0007813), or a ceramic plate is installed on a heating plate (Korean Patent Registration No. 10-0668108).

However, when electric hair irons having these heating plates formed of aluminum or ceramic are used to style hair, moisture in the hair is rapidly evaporated and heat destroys the cuticular layer of the hair. Thereby, the state of the hair is deteriorated, styling of the hair is not properly carried out, or the hair loses its shine or health.

In order to solve these problems, Korean Utility Model Unexamined Publication No. 20-2016-0003860 (entitled “Heating plate for electric iron”) is disclosed.

As shown in FIG. 1, a heating plate 100 for an electric iron includes a heater 102 which generates heat when power is supplied thereto, and an aluminum heating plate 104 installed to surround one surface and both sides of the heater 102 and having excellent thermal conductivity to easily emit the heat generated by the heater 102 to the outside.

Further, the entire upper surface of the aluminum heating plate 104 is coated with a silicone adhesive 106.

Further, a Teflon sheet 108 is installed on the upper surface of the silicone adhesive 106, and the Teflon sheet 108 is firmly and integrally adhered to the aluminum heating plate 104 by the silicone adhesive 106 without being separated from the aluminum heating plate 104. The thickness t of the Teflon sheet 108 may be maintained at about 0.1 mm to 0.6 mm. The reason for this is to maintain durability and strength.

However, in such a heating plate, the Teflon sheet is adhered to the heating plate, and thus when air bubbles formed therein are not removed, a corresponding portion is inflated due to heat, adhesive force is weakened due to curing of the silicone adhesive, and thus the tip of the sheet is peeled off from the heating plate.

### DISCLOSURE

### Technical Problem

Therefore, the present invention has been made in view of the above problems, and it is an object of the present invention to provide a heating plate for an electric hair iron having a soft synthetic resin inserted therein and a method for manufacturing the same, in which an aluminum heating plate having a plurality of grooves formed in a longitudinal direction on the front surface thereof is prepared through injection molding, and the soft synthetic resin is injected into the front surface and both side surfaces of the aluminum heating plate in a state of being inserted into a mold such that some of the soft synthetic resin is inserted into the grooves so as to be integrated with the aluminum heating plate.

It is another object of the present invention to provide a heating plate for an electric hair iron having a soft synthetic resin inserted therein and a method for manufacturing the same, in which a soft synthetic resin is injected into an aluminum heating plate in a direction from the rear surface to the front surface of the aluminum heating plate when injecting the soft synthetic resin, and thus a uniform soft synthetic resin layer is formed without generating bubbles on the front surface of the aluminum heating plate.

It is a further object of the present invention to provide a heating plate for an electric hair iron having a soft synthetic resin inserted therein and a method for manufacturing the same, in which a hollow-type through hole is formed between grooves of an aluminum heating plate so as to enable uniform heat transfer, and a ceramic coating layer is formed inside the grooves so as to enable uniform heat transfer to a soft synthetic resin layer.

### Technical Solution

In accordance with an aspect of the present invention, the above and other objects can be accomplished by the provision of,

a method for manufacturing a heating plate for an electric hair iron having a soft synthetic resin inserted therein, the method including preparing an aluminum heating plate, formed as a hollow-type rectangular pipe having a rear surface, which is partially open so that a heater is adhered to an inside thereof, and having grooves formed in a longitudinal direction on an upper surface of the aluminum heating plate, through injection molding and cutting the prepared aluminum heating plate to a designed length, and injecting the soft synthetic resin into the aluminum heating plate in a state of being inserted into a mold so as to form an even soft synthetic resin layer on a front surface and both side surfaces of the aluminum heating plate such that some of the soft synthetic resin is inserted into the grooves so as to be integrated with the aluminum heating plate.

The method may further include forming a ceramic coating layer inside the grooves to uniformly transfer heat to the soft synthetic resin layer.

In the preparing the aluminum heating plate through injection molding and the cutting the aluminum heating plate, a hollow-type heat diffusion hole may be formed between the grooves so as to uniformly distribute heat over the front surface of the aluminum heating plate.

Each of the grooves may include an extension part formed vertically, and an expansion part expanding from an end of the extension part to have one shape selected from among a circle, a triangle, a rectangle and a polygon.

In the injecting the soft synthetic resin into the aluminum heating plate, the soft synthetic resin may be injected into the aluminum heating plate in a direction from the rear surface to the front surface of the aluminum heating plate through a plurality of resin filling holes formed perpendicularly to the grooves so as to prevent generation of bubbles on the front surface of the aluminum heating plate and to form the soft synthetic resin layer having excellent flatness.

In accordance with another aspect of the present invention, there is provided,

a heating plate for an electric hair iron having a soft synthetic resin inserted therein, manufactured by the above-described.

### Advantageous Effects

In a heating plate for an electric hair iron having a soft synthetic resin inserted therein and a method for manufacturing the same in accordance with the present invention, an aluminum heating plate having a plurality of grooves formed in a longitudinal direction on the front surface thereof is prepared through injection molding, and the soft synthetic resin is injected into the front surface and both side surfaces of the aluminum heating plate in a state of being inserted into a mold such that some of the soft synthetic resin is inserted into the grooves so as to be integrated with the aluminum heating plate.

Further, the soft synthetic resin is injected into the aluminum heating plate in a direction from the rear surface to the front surface of the aluminum heating plate when injecting the soft synthetic resin, and thus a uniform soft synthetic resin layer may be formed without generating bubbles on the front surface of the aluminum heating plate.

In addition, a hollow-type through hole is formed between the grooves of the aluminum heating plate so as to enable uniform heat transfer, and a ceramic coating layer is formed inside the grooves so as to enable uniform heat transfer to the soft synthetic resin layer.

### DESCRIPTION OF DRAWINGS

FIG. 1 is a cross-sectional view of a conventional heating plate for an electric hair iron.

FIG. 2 is a perspective view of a heating plate for an electric hair iron having a soft synthetic resin inserted therein in accordance with the present invention.

FIG. 3 is a cross-sectional view taken along line A-A of FIG. 2.

FIG. 4 is a cross-sectional view illustrating the configuration of a heating plate for an electric hair iron having a soft synthetic resin inserted therein in accordance with another embodiment of the present invention.

FIG. 5 is a cross-sectional view illustrating the configurations of grooves of FIG. 3.

FIG. 6 is a flowchart illustrating a method for manufacturing a heating plate for an electric hair iron having a soft synthetic resin inserted therein in accordance with the present invention.

FIGS. 7 to 10 are views illustrating the method for manufacturing the heating plate in accordance with the present invention.

FIG. 11 is a flowchart illustrating a method for manufacturing a heating plate for an electric hair iron having a soft synthetic resin inserted therein in accordance with another embodiment of the present invention.

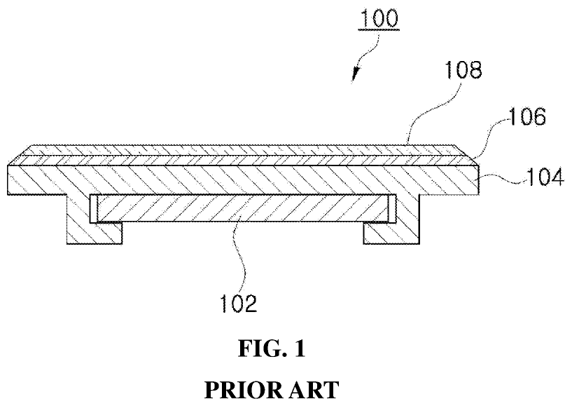

### BEST MODE

A method for manufacturing a heating plate for an electric hair iron having a soft synthetic resin inserted therein in the best mode in accordance with the present invention includes preparing an aluminum heating plate, formed as a hollow-type rectangular pipe having a rear surface, which is partially open so that a heater is adhered to an inside thereof, and having grooves formed in a longitudinal direction on an upper surface of the aluminum heating plate, through injection molding and cutting the aluminum heating plate to a designed length, and injecting the soft synthetic resin into the aluminum heating plate in a state of being inserted into a mold so as to form an even soft synthetic resin layer on a front surface and both side surfaces of the aluminum heating plate such that some of the soft synthetic resin is inserted into the grooves so as to be integrated with the aluminum heating plate.

### MODE FOR INVENTION

Hereinafter, a heating plate for an electric hair iron having a soft synthetic resin inserted therein in accordance with embodiments of the present invention will be described in detail with reference to the accompanying drawings.

In the following description of the present invention, a detailed description of known functions and configurations incorporated herein will be omitted when it may make the subject matter of the present invention rather unclear. Also, the terms used in the following description are terms defined taking into consideration the functions obtained in accordance with the present invention. The definitions of these terms should be determined based on the whole content of this specification because they may be changed in accordance with the intention of a user or an operator or a usual practice.

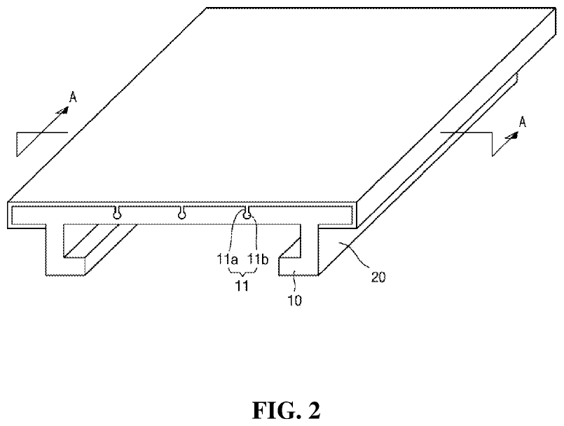

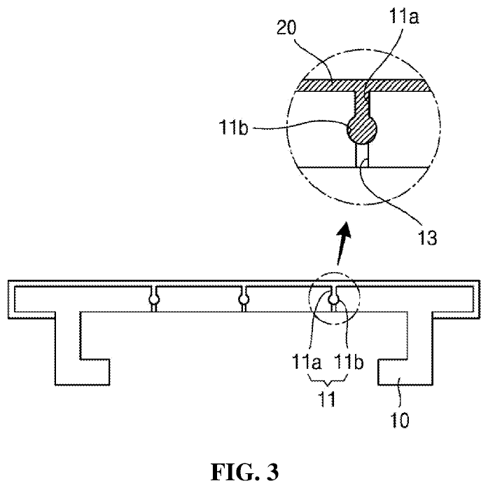

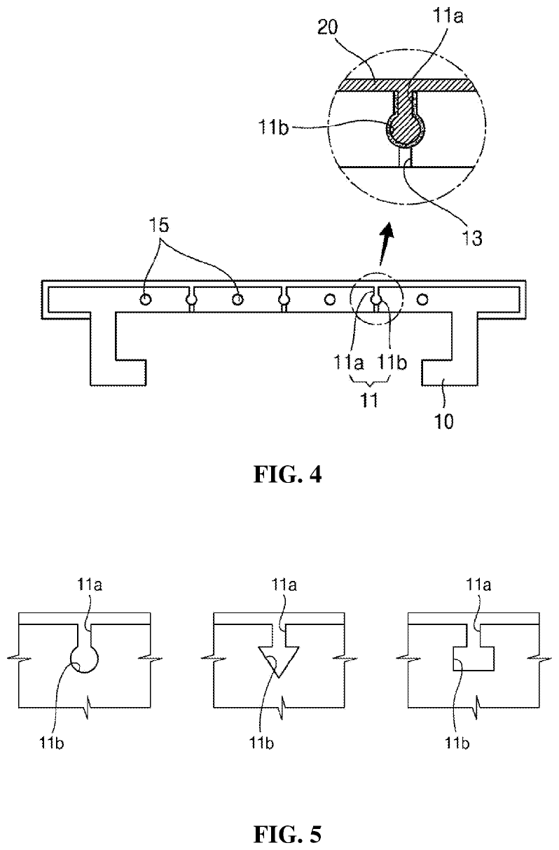

FIG. 2 is a perspective view of a heating plate for an electric hair iron having a soft synthetic resin inserted therein in accordance with the present invention, FIG. 3 is a cross-sectional view taken along line A-A of FIG. 2, FIG. 4 is a cross-sectional view illustrating the configuration of a heating plate for an electric hair iron having a soft synthetic resin inserted therein in accordance with another embodiment of the present invention, and FIG. 5 is a cross-sectional view illustrating the configurations of grooves of FIG. 3.

Referring to FIGS. 2 to 5, a heating plate 1 for an electric hair iron having a soft synthetic resin inserted therein in accordance with the present invention includes an aluminum heating plate 10 and a soft synthetic resin layer 20.

First, the aluminum heating plate 10 is formed of a material which is generally used, and is formed as a hollow-type rectangular pipe having the rear surface which is partially open so that a heater (not shown) is adhered to the inside thereof, and grooves 11 are formed in a longitudinal direction on the upper surface of the aluminum heating plate 10. Here, the heating plate 10 is prepared through injection molding and is then cut to a designed length, like a conventional aluminum profile.

Further, the groove 11 may include an extension part 11a formed vertically and an expansion part 11b formed at the end of the extension part 11a to have one shape selected from among a circle, a triangle and a rectangle, as shown in FIG. 5, and, as needed, one groove 11 may be formed at the center of the aluminum heating plate or a plurality of grooves 11 may be formed at the same interval. Here, the expansion part 11b may be formed to have a polygonal shape.

Further, the aluminum heating plate 10 has a plurality of resin filling holes 13 formed perpendicularly to the grooves 11 so as to prevent generation of bubbles on the front surface of the aluminum heating plate 10 and to form the soft synthetic resin layer 20 having excellent flatness. Here, Teflon resin may be used as the soft synthetic resin.

Further, the aluminum heating plate 10 may have hollow-type heat diffusion holes 15 between the groove 11 and the groove 11 so as to uniformly distribute heat over the front surface of the aluminum heating plate, as shown in FIG. 4.

In addition, the aluminum heating plate 10 may have a ceramic coating layer 17 formed inside the grooves so as to prevent the soft synthetic resin filling the extension parts 11a and expansion parts 11b of the grooves 11 from blocking heat transfer to the soft synthetic resin layer 20 and to uniformly transfer heat, as shown in FIG. 4. Here, as the ceramic coating layer 17, a mixture of a particulate ceramic material and an adhesive may be applied.

Thereafter, fine grooves (not shown) may be formed in a designated pattern on the front surface and side surfaces of the aluminum heating plate 10 so that the soft synthetic resin layer 20 is effectively adhered to the surfaces of the aluminum heating plate 10.

Further, the soft synthetic resin layer 20 is formed on the front surface and both side surfaces of the aluminum heating plate 10 in a state of being inserted into a mold 30, to a designated thickness (about 0.1-1.0 mm) due to injection so as to be integrated with the aluminum heating plate 10. Here, the soft synthetic resin includes a fluorine-carbide-based resin which is basically one of three types, i.e., Poly Tetra Fluore Ethylene (PTFE), Fluorinated EthyleneProphylene (FEP) and Per Fluore Alkoxy (PFA), and has properties, including non-adhesion in which almost no material is not adhered to a material, self-lubrication in which moisture or oil does not stick to a material, heat resistance in which a material is not decomposed even at a high temperature (260° C.), low-temperature durability in which the physical properties of a material are not changed even at a low temperature, and noninfluence of the surrounding chemical environment.

For these reasons, the soft synthetic resin layer in accordance with the present invention maximally maintains hair moisturizing, and prevents a vapor phenomenon (vaporization phenomenon).

Further, self-lubrication of the soft synthetic resin layer 20 is transferred to hair which is treated and thus makes the hair smooth and soft, a fluorine compound contained in the soft synthetic resin layer 20 functions to protect the hair from ultraviolet light, detergents or environmental pollution while allowing the hair to maintain elasticity thereof, and the electrical insulation function of fluorine serves to intercept harmful electromagnetic waves induced by the heater, which generates heat due to power supply, so as to prevent the harmful electromagnetic waves from influencing users.

Hereinafter, a method for manufacturing a heating plate for an electric hair iron having a soft synthetic resin inserted therein in accordance with the present invention will be described in detail with reference to the accompanying drawings.

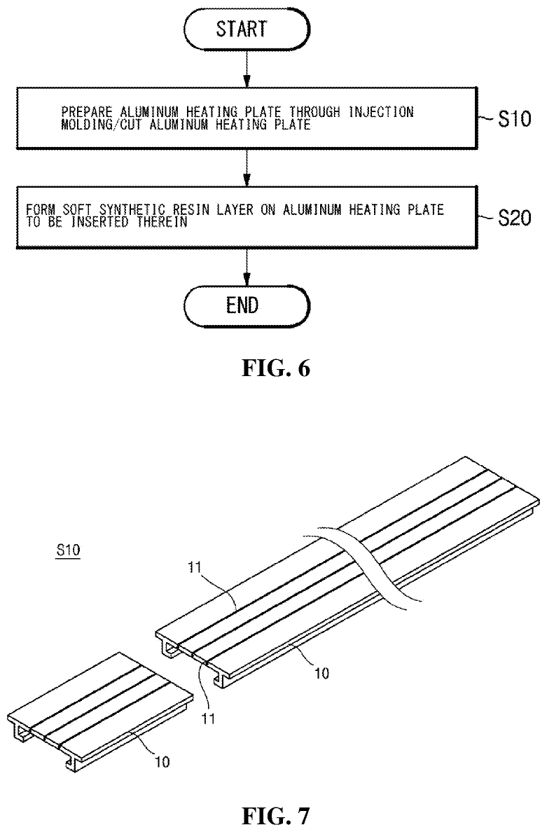

FIG. 6 is a flowchart illustrating a method for manufacturing a heating plate for an electric hair iron having a soft synthetic resin inserted therein in accordance with the present invention, and FIGS. 7 to 10 are views illustrating the method for manufacturing the heating plate in accordance with the present invention.

Referring to FIGS. 6 to 10, the method for manufacturing the heating plate in accordance with the present invention comprises preparation of a heating plate through injection molding and cutting (operation S10) and injection (operation S20)

«Preparation of Heating Plate Through Injection Molding and Cutting—Operation S10»

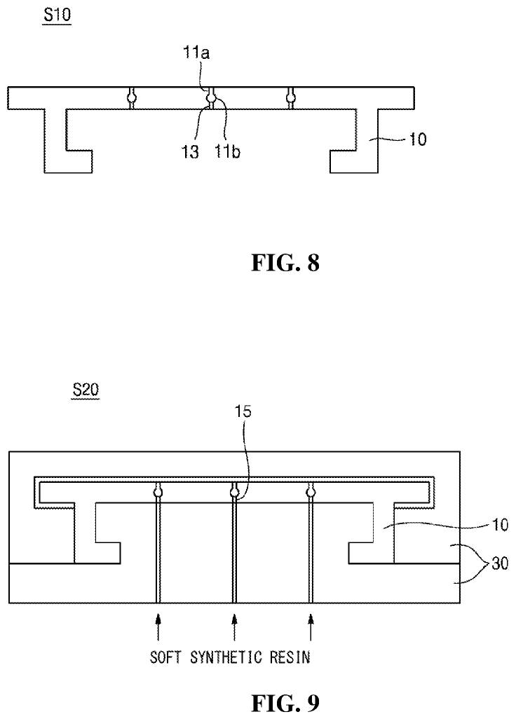

First, as shown in FIGS. 7 and 8, an aluminum heating plate 10, formed as a hollow-type rectangular pipe having the rear surface which is partially open so that a heater (not shown) is adhered to the inside thereof, and having grooves 11 formed in a longitudinal direction on the upper surface of the aluminum heating plate 10 and resin filling holes 13 formed perpendicularly to the grooves 11, is prepared through injection molding, and is cut to a designed length. Here, fine grooves (not shown) may be formed in a designated pattern on the front surface and side surfaces of the aluminum heating plate 10 so that a soft synthetic resin layer 20 is effectively adhered to the surfaces of the aluminum heating plate 10, and heat diffusion holes 15 may be formed between the groove 11 and the groove 11.

«Injection—Operation S10»

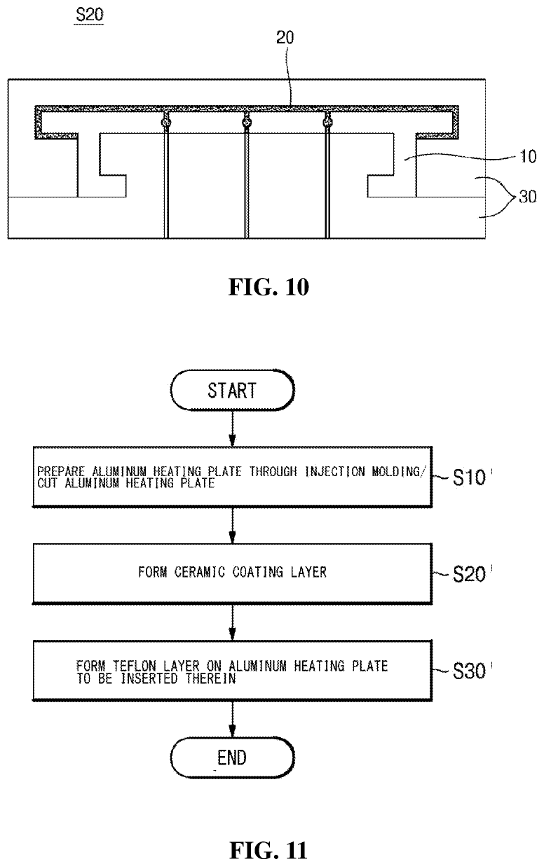

When the preparation of the aluminum heating plate 10 is completed or coating of the aluminum heating plate with a ceramic coating layer 17 is completed, as shown in FIGS. 9 and 10, the soft synthetic resin is injected into the aluminum heating plate 10 in a state of being inserted into a mold 30, in a direction from the rear surface to the front surface of the aluminum heating plate 10 through the resin filling holes 13 so that the soft synthetic resin layer 20 is formed on the front surface and both side surfaces of the aluminum heating plate 10 to a designated thickness (about 0.1-1.0 mm) so as to be integrated with the aluminum heating plate 10.

Next, a method for manufacturing a heating plate for an electric hair iron having a soft synthetic resin inserted therein in accordance with another embodiment of the present invention will be described in detail with reference to the accompanying drawings.

FIG. 11 is a flowchart illustrating a method for manufacturing a heating plate for an electric hair iron having a soft synthetic resin inserted therein in accordance with another embodiment of the present invention.

Referring to FIG. 11, the method for manufacturing the heating plate in accordance with another embodiment of the present invention comprises preparation of a heating plate through injection molding and cutting (operation S10′), ceramic coating (operation S20′) and injection (operation S30′)

«Preparation of Heating Plate Through Injection Molding and Cutting—Operation S10′»

First, an aluminum heating plate 10, formed as a hollow-type rectangular pipe having the rear surface which is partially open so that a heater (not shown) is adhered to the inside thereof, and having grooves 11 formed on the upper surface of the aluminum heating plate 10 in a longitudinal direction and resin filling holes 13 formed perpendicularly to the grooves 11, is prepared through injection molding, and is cut to a designed length. Here, fine grooves (not shown) may be formed in a designated pattern on the front surface and side surfaces of the aluminum heating plate 10 so that a soft synthetic resin layer 20 is effectively adhered to the surfaces of the aluminum heating plate 10, and heat diffusion holes 15 may be formed between the groove 11 and the groove 11.

«Ceramic Coating—Operation S20′»

When the preparation of the aluminum heating plate 10 is completed, a ceramic coating layer 17 is formed inside the grooves so as to prevent the soft synthetic resin filling the extension parts 11a and the expansion parts 11b of the grooves 11 from blocking heat transfer to the soft synthetic resin layer 20 and to uniformly transfer heat. Here, as the ceramic coating layer 17, a mixture of a particulate ceramic material and an adhesive may be applied, and selectively, the ceramic coating layer 17 may be formed further on the front surface and the side surfaces of the aluminum heating plate 10 so as to increase heat transfer efficiency.

«Injection—Operation S30′»

When the preparation of the aluminum heating plate 10 is completed or the coating of the aluminum heating plate with the ceramic coating layer 17 is completed, the soft synthetic resin is injected into the aluminum heating plate 10 in a state of being inserted into a mold 30, in a direction from the rear surface to the front surface of the aluminum heating plate 10 through the resin filling holes 13 so that the soft synthetic resin layer 20 is formed on the front surface and both side surfaces of the aluminum heating plate 10 to a designated thickness (about 0.1-1.0 mm) so as to be integrated with the aluminum heating plate 10.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### DESCRIPTION OF REFERENCE MARKS AND NUMERALS

10: aluminum heating plate 11: groove
13: resin filling hole 15: heat diffusion hole
17: ceramic coating layer 20: soft synthetic resin layer

1. A method for manufacturing a heating plate for an electric hair iron having a soft synthetic resin inserted therein, the method comprising:
preparing an aluminum heating plate, formed as a hollow-type rectangular pipe having a rear surface, which is partially open so that a heater is adhered to an inside thereof, and having grooves formed in a longitudinal direction on an upper surface of the aluminum heating plate, through injection molding and cutting the prepared aluminum heating plate to a designed length; and
injecting the soft synthetic resin into the aluminum heating plate in a state of being inserted into a mold so as to form an even soft synthetic resin layer on a front surface and both side surfaces of the aluminum heating plate such that some of the soft synthetic resin is inserted into the grooves so as to be integrated with the aluminum heating plate.

2. The method according to claim 1, further comprising forming a ceramic coating layer inside the grooves to uniformly transfer heat to the soft synthetic resin layer.

3. The method according to claim 1, wherein, in the preparing the aluminum heating plate through injection molding and the cutting the aluminum heating plate, a hollow-type heat diffusion hole is formed between the grooves so as to uniformly distribute heat over the front surface of the aluminum heating plate.

4. The method according to claim 1, wherein each of the grooves comprises:
an extension part formed vertically; and
an expansion part expanding from an end of the extension part to have one shape selected from among a circle, a triangle, a rectangle and a polygon.

5. The method according to claim 1, wherein, in the injecting the soft synthetic resin into the aluminum heating plate, the soft synthetic resin is injected into the aluminum heating plate in a direction from the rear surface to the front surface of the aluminum heating plate through a plurality of resin filling holes formed perpendicularly to the grooves so as to prevent generation of bubbles on the front surface of the aluminum heating plate and to form the soft synthetic resin layer having excellent flatness.

6. A heating plate for an electric hair iron having a soft synthetic resin inserted therein, manufactured by the method according to claim 1.
